(19) United States
(12) Patent Application Publication
(10) Pub. No.: US 2014/0260080 A1
(43) Pub. Date: Sep. 18, 2014

(54) REINFORCED DOOR SKIN, REINFORCED DOOR INCLUDING THE SAME, AND METHODS OF MAKING SAME

(71) Applicant: Masonite Corporation, Tampa, FL (US)

(72) Inventors: Steven SWARTZMILLER, Batavia, IL (US); James P. PFAU, Kirkland, IL (US); James BRYANT, Chicago, IL (US); Kurt LILLIE, Petal, MS (US)

(73) Assignee: Masonite Corporation, Tampa, FL (US)

(21) Appl. No.: 14/206,401

(22) Filed: Mar. 12, 2014

Related U.S. Application Data
(60) Provisional application No. 61/777,180, filed on Mar. 12, 2013.

(51) Int. Cl. E06B 3/72; B32B 7/12; B32B 3/28

(52) U.S. Cl. CPC E06B 3/72; B32B 3/28; B32B 7/12
USPC 52/784.1; 156/60; 156/327; 156/331.7; 156/332; 156/334; 428/187

(57) ABSTRACT

Reinforced door skins, a door including one or more of the reinforced door skins, and methods of making the reinforced door skins and door are provided. The reinforced door skin as made by providing a reinforcement backing having a fibrous substrate layered with a solid-state thermoplastic hot melt adhesive, pressing the reinforcement backing and a preformed board having a door skin shape against one another at a temperature above a melt temperature of the thermoplastic hot melt adhesive and at sufficiently high pressure to conform the reinforcement backing to the door skin shape of the preformed board, and cooling the thermoplastic hot melt adhesive to form a reinforced door skin, the thermoplastic hot melt adhesive fusing the fibrous substrate to the preformed board of the reinforced door skin.

### CROSS REFERENCE TO RELATED APPLICATION AND CLAIM TO PRIORITY

This application claims the benefit of priority under 35 U.S.C. 119(e) of U.S. provisional application Ser. No. 61/777,180 filed on Mar. 12, 2013, the complete disclosure of which is incorporated herein by reference.

### FIELD OF THE INVENTION

The present invention relates to reinforced door skins, particularly impact resistant reinforced door skins, reinforced doors including one or more of the reinforced door skins, and methods of making reinforced door skins and reinforced doors.

### BACKGROUND

Door skins (also known and referred to herein as “door facings”) may be secured to a support structure such as a frame to form a hollow core door. Door skins may include one or more molded contours, such as one or more square, rectangular, oval, or circular depressions or grooves recessed into the major surface of the door skin. These depressions may define the perimeter of one or more simulated internal panels. The internal panels typically are raised above, coplanar with, or recessed below the main surface of the door skin. The door skin may also include other surface features, including embossed features, such as strike lines and grain patterns. Strike lines may simulate the appearance of the plank edges, such as horizontally extending planks (or rails) and vertically extending planks (or stiles). Grain patterns may simulate the appearance of wood grain and impart texture to the surface of the door skin. Alternatively, the door skins may be “flush” or non-contoured.

Door skins typically are mounted on and secured to opposing surfaces of the support structure, which as mentioned above is typically a rectangular frame. The door skins typically are spaced from one another when secured on the opposing surfaces of the frame, thereby creating one or more cavities between the door skins with an outer boundary of the cavity defined by the frame. A core component often is situated in the cavity. Where multiple cavities are present between the door skins, one or more core components may be placed in each cavity or in selected cavities. Conventional core materials for use in hollow core doors include corrugated cardboard, paper, foam, and fiberboard. Certain materials, such as foam, are formable in situ in the cavity. For alternative core component materials that are preformed, the core component may be placed into the hollow space before or after one door skin is secured to the frame. The other door skin then is secured to the opposite surface of the frame to seal the core component between the door skins.

It is sometimes desirable to provide a door with high impact resistant properties so that the door is suitable for use as an exterior door capable of withstanding impact from flying debris that might be propelled towards the door by high velocity winds experienced during severed weather conditions, such as hurricanes or tornadoes. Doors are sometimes required to pass certain performance tests, such as those developed by the American Society of Testing Materials (ASTM). Such performance tests measure the performance of doors exposed to the effects of wind generated during storms. Doors may also be required to meet regional performance tests within a particular State. For example, the Florida Building Code sets out stringent requirements for building components so that buildings can withstand hurricanes and other severe weather conditions. The Testing Application Standard 201-94 (TAS 201) is designed to test a product's resistance to windborne debris. To pass the test, the glazed panel must withstand a Large Missile Impact test. The missile used in the test is a 9 pound, 7-9 foot Southern Yellow Pine 2×4. The missile is placed 17 feet from the tested unit, and launched so that the missile attains a speed of 35 miles per hour (50 feet/second) immediately before/upon impacting the target face of the glazed panel, as specified in Florida Building Code, Building (2004), Section 1626.2.4. After the TAS 201 test is performed, a TAS 203-94 (TAS 203) test is carried out. The same glazed panel is used for the TAS 201 test and the TAS 203 test. The TAS 203 test is designed to evaluate the resistance of the product to cyclic pressure differentials that may occur as a hurricane passes through a geographical area. The pressure is applied to a first side of the glazed panel at varying cycle pressures. Next, a vacuum is applied to the same side. The cycling of pressure and vacuum is continued on the glazed unit during the TAS-203 test, as applied in the Florida Building Code, Building (2004) Section 1626, Table 16.26, for a total of 9000 wind pressure cycles, i.e., 4500 positive wind pressure cycles, 4500 negative wind pressure cycles. The above TAS tests and Florida Building Code sections are incorporated herein by reference.

### SUMMARY OF THE INVENTION

According to a first aspect of the invention, a method of making a reinforced door skin features providing a reinforcement backing including a fibrous substrate layered with a solid-state heat-meltable adhesive, pressing the reinforcement backing and a preformed board having a door skin shape against one another at sufficiently high temperature to melt the adhesive and at sufficiently high pressure to conform the reinforcement backing to the door skin shape of the preformed board, and cooling the adhesive to fuse the fibrous substrate to the preformed board and form a reinforced door skin.

A second aspect of the invention provides a reinforced door skin featuring a preformed board configured and dimensioned as a door skin having an exterior surface and an opposite interior surface, a fibrous substrate, and a solid-state adhesive fusing the fibrous substrate to the interior surface of the preformed board.

A third aspect of the invention provides a method of making a door assembly. A reinforcement backing including a fibrous substrate layered with a solid-state heat-meltable adhesive is provided. The reinforcement backing and a preformed board having a door skin shape are pressed against one another at sufficiently high temperature to melt the adhesive and at sufficiently high pressure to conform the reinforcement backing to the door skin shape of the preformed board. The adhesive is cooled. In the resulting reinforced first door skin, the adhesive fuses the fibrous substrate to the preformed board. The reinforced first door skin is secured to a first surface of a door support/frame, and a second door skin (which may be reinforced or non-reinforced, identical to or different than the reinforced first door skin) is secured to an opposite second surface of the door support/frame.

A fourth aspect of the invention provides a door assembly including a door support/frame, a reinforced first door skin secured to a first side of the door support/frame, and a second door skin secured to an opposite second side of the door support/frame. The reinforced first door skin features a preformed board configured and dimensioned as a door skin having an exterior surface and an opposite interior surface, a fibrous substrate, and a solid-state adhesive that fuses the fibrous substrate to the interior surface of the preformed board.

According to an embodiment of the above aspects, the fibrous substrate comprises a woven or non-woven fabric, a mesh, a felt, or a knitted substrate.

In accordance with another embodiment of the above aspects, the fibrous substrate is made of fiberglass and/or aramid fibers.

Another embodiment of the above aspects involves preparing the reinforcing backing by pre-melting the adhesive onto at least one surface of the fibrous substrate, and cooling the pre-melted adhesive to the solid state prior to pressing.

Still another embodiment of the above aspects features pressing at a temperature in a range of about 66° C. to about 150° C. and/or pressing at a pressure in a range of about 2 psi to about 1000 psi.

In accordance with embodiments described herein, the door skin shape is contoured, and the pressing is performed in a pressing apparatus having cavity-forming surfaces that are substantially identical in contour to the contoured door skin shape of the preformed board.

In yet another embodiment of the above aspects, the door skin shape of the preformed board includes a contour that is not altered in shape during pressing.

Examples of thermoplastic hot melt adhesives that may be practiced with the aspects described above include polyolefins such as polyethylene and polypropylene, polyethylene vinyl acetate, and copolymers, terpolymers, and blends including at least one of the polyethylene, polypropylene, and polyethylene vinyl acetate.

Another embodiment that may be practiced in connection with the above aspects involves the use of a barrier layer to prevent or at least reduce direct contact between the adhesive and one or more of the mold dies.

The embodiments and aspects discussed above may be practiced in any combination with one another.

Other aspects of the invention, including apparatus, articles, methods, systems, assemblies, and the like which constitute part of the invention, will become more apparent upon reading the following detailed description of the exemplary embodiments.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a front elevation of an exemplary reinforced door;

FIG. 2 is a fragmentary cross-sectional view taken along sectional line II-II of FIG. 1;

FIG. 2A is a fragmentary cross-sectional view of another embodiment taken along sectional line II-II of FIG. 1;

FIG. 2B is a fragmentary cross-sectional view of yet another embodiment taken along sectional line II-II of FIG. 1;

FIG. 2C is a fragmentary cross-sectional view of still another embodiment taken along sectional line II-II of FIG. 1;

FIG. 2D is a fragmentary cross-sectional view of a further embodiment taken along sectional line II-II of FIG. 1;

FIG. 3 is a flowchart of a method of making a reinforced door skin in accordance with an embodiment of the invention;

FIG. 4 is a fragmentary sectional schematic of a loading step of a method for forming a reinforced door skin in a pressing apparatus according to an embodiment of the invention;

FIG. 4A depicts a modification to the loading step of FIG. 4;

FIG. 5 is a fragmentary sectional schematic of a pressing step of the method of FIG. 4;

FIG. 5A depicts a modification to the pressing step of FIG. 5;

FIG. 6 is a view of a process for making a reinforcement backing for the reinforced door skin; and

FIG. 7 is a view of another process for making a reinforcement backing for the reinforced door skin.

### DETAILED DESCRIPTION OF THE EXEMPLARY EMBODIMENTS AND EXEMPLARY METHODS

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

As best shown in FIGS. 1 and 2, an exemplary hollow core door 10 includes rectangular first and second reinforced door skins 12 and 14. The reinforced door skins 12 and 14 include a main body 16 substantially lying in a first plane, interior panels 18, and contoured areas 20 surrounding the interior panels 18, interconnecting the main body 16 to the contoured areas 20, and extending to a second plane. As best shown in FIG. 2-2D, the contoured areas 20 are characterized by contours on both the exterior surfaces and the interior surfaces of the door skins. While the exemplary embodiments are primarily described herein with reference to one-panel (interior panel) and multi-panel doors, such as the six-panel door of FIG. 1, it should be understood that the embodiments described herein may comprise alternative contoured arrangements or be used to make flush reinforced door skins. Additionally, the exterior surfaces of the door skins may have embossed or other features in the exterior surface, such as wood grain.

As best shown in FIG. 2, the reinforced door skins 12, 14 have exterior surfaces 12a, 14a and interior surfaces 12b, 14b. The interior surfaces 12b, 14b face one another and are concealed from view when the hollow core door 10 is assembled. The exterior surfaces 12a, 14a of the door 10 face away from one another and are viewable to (not concealed in the hollow core from) the user. The reinforced door skins 12, 14 are relatively thin, and may have a thickness on the order of, for example, about 1.5 mm (about 60 mils) to about 4.5 mm (about 175 mils), more typically about 1.5 mm (about 60 mils) to about 3.3 mm (about 130 mils). In the case of steel skins 12, 14, the thickness may be on the order of, for example, approximately 0.020 inch (25 gauge).

The interior surfaces 12b, 14b of the door skins 12, 14 are mounted and secured to the opposite sides of a rectangular door frame 26. An end cap or siding member 27 is positioned along the outer peripheral edge of the frame 26. The end cap or siding member 27 may be made of plastic, a composite material, wood, or a veneer, among other materials. Although. FIG. 2 shows only one of the side vertical components or “stiles” of the door frame 26, it is understood in the art that door frames such as door frame 26 will typically include at least first and second stiles respectively positioned on opposite sides of the door 10 and first and second horizontal components or “rails” respectively positioned at the top and bottom of the door 10. The top and bottom rails and left and right stiles may each include the end cap or siding member 27 extending along its outer length. The door frame 26 may include additional stiles and/or rails, and other features as known in the art, such as lock blocks (see, e.g., U.S. Pat. No. 7,644,551). The door frame 26 may be made of wood, metal, composite, and/or other materials. Fasteners and/or adhesive, such as polyvinyl acetate, secure the reinforced door skins 12 and 14 to the opposite surfaces of the door frame 26.

The door frame 26 is sufficiently thick so that the reinforced door skins 12 and 14 secured to the opposite surfaces of the frame 26 are spaced apart from one another to establish a hollow cavity (or cavities, particularly if the frame 26 includes intermediate rails and/or intermediate stiles) 28. Although not shown, the cavity 28 may be filled with one or more core components, such as corrugated cardboard, paper, foam, or fiberboard. Door core components are described in, for example, U.S. Pat. Nos. 8,341,919, 8,317,959, and 6,764,625.

The reinforced door skins 12, 14 each include a preformed board (also referred to as a panel) 22 and a reinforcement backing 24. As shown in the embodiment of FIG. 2, the preformed board 22 and the reinforcement backing 24 are coextensive with one another to both terminate at the inner face of the end cap or siding member 27. In an alternative embodiment shown in FIG. 2A, the reinforcement backing 24 has a lesser width and lesser length than the preformed board 22, i.e., the reinforcement backing 24 and the preformed board 22 are not coextensive with one another. For example, in FIG. 2A, the reinforcement backing 24 terminates at the inner edge of the door frame 26, while the preformed board 22 extends beyond the reinforcement backing 24 and along the opposite surfaces of the door frame 26 before terminating at the inner face of the end cap or siding member 27. FIG. 2B shows a modification to the embodiment of FIG. 2A in which the reinforcement backing 24 also extends along the inner face of the frame 26, opposite to the end cap or siding member 27. FIG. 2 may be similarly modified to include the reinforcement backing 24 along the inner face of the frame 26. Combinations of these and other embodiments disclosed herein are contemplated. Each of these and other embodiments may be further modified to include multiple (e.g., two, three, etc.) layers of reinforcement backing 24 over a portion or the entirety of the preformed board 22, particularly where additional reinforcement is needed or desired.

The preformed board 22 may be made of a polymer composition, such as a sheet molding compound (SMC), bulk molding compound (BMC), or thick molding compound (TMC) substantially or fully cured into a thermoset. SMC and similar polymer composite materials are made of thermosetting resin systems typically including an unsaturated polyester or vinyl ester resin, a thickening agent, a thermoplastic polymer such as low shrinkage and/or low profile additive, and a reactive monomer such as styrene or oligomer. Typically, the composite materials also include fibers, especially fiberglass. The length of the individual cut glass fibers may be, for example, about 1.27 cm (0.5 inch) to about 2.54 cm (1 inch). Alternatively, the fiberglass of the SMC or other composition may be formed of a fiberglass mat. The polymer compositions of the preformed boards 22 may also include catalysts, activating agents, thickening agents, stabilizers, additives, and fillers such as calcium carbonate, talc, etc. Examples of polymer compositions including nano-components (which are optional herein) are described in U.S. Patent Publication No. 2008/0016819. Compositions similar to those described in the aforementioned publication, with or without nano-components, may be useful.

Alternatively, the preformed boards 22 may be made of wood, composites, steel, glass, or other solid materials. Representative cellulosic composite materials that may be used include medium density fiberboard (MDF) and high density fiberboard (HDF). The cellulose material may be present as fibers, particles, sawdust, etc. The cellulosic material typically is wood, although other cellulosic materials may be used. The preformed boards 22 of the door skins 12, 14 may be, but are not necessarily, identical in composition, configuration, and appearance (e.g., contours 20, strike lines, number of internal panels, embossments, finish) to one another.

The reinforcement backings 24 of the reinforced door skins 12, 14 may be, but are not necessarily, identical to one another in composition, configuration and appearance. Although not shown, doors having a reinforced door skin 12 and a non-reinforced door skin may be used in assembling a door. The reinforcement backing 24 of the door skins 12, 14 include a continuous fibrous substrate 24a (FIG. 4) adhered/“tacked” or fused to a thermoplastic hot melt adhesive layer 24b that is in a solid state at room temperature and other temperatures typically encountered in normal use, e.g., from about −18° C. (0° F.) to about 49° C. (120° F.). The continuous fibrous substrate 24a may take the form of a sheet, mesh, felt, fabric, or mat. The fibrous substrate 24a may be knitted, woven, non-woven, conformable, stitched, solid, cast, or stamped. The continuous fibrous substrate 24a does not necessarily extend unbroken or a unitary/integral sheet across the entire width or height of the interior core area. Multiple fibrous substrates (that may be identical to or different from one another) may be arranged end to end, for example, to form the fibrous substrate. Areas requiring additional reinforcement may be provided with two, three, or more layers of fibrous material.

The fibers may include one or more of glass fibers, aramid fibers (e.g., Kevlar®), carbon fibers, natural fibers, polymer fibers, mineral fibers, steel fibers, engineered reinforcements. Suitable fiberglass fabrics for use in these exemplary embodiments include BGF 3732 woven fabric, Chomarat Rovicore®, Owens Corning continuous strand mat or Uniform® material. Chopped fibers may have a length of, for example, about 1.27 cm (about 0.5 inch) to about 15.24 cm (about 6 inches). Woven fibers are typically longer.

The door skins 12, 14 of FIGS. 2, 2A, and 2B may include one or more additional layers other than the fiber reinforcement material of layers 24. For example, the door skins 12, 14 of the alternative embodiments shown in FIGS. 2C and 2D include an additional layer 29 applied to the interior surfaces of the reinforcement backing 24. Additional layer 29 may be made of, for example, sound deadening or damping material, fire retardant (intumescent) material, or combinations including the same. The additional layer 29 may be adhered to the interior surface of the reinforcement backing 24 using a thermoplastic hot melt adhesive.

According to an exemplary embodiment shown in FIG. 6, the reinforcement backing 24 is prepared in a continuous process by applying the thermoplastic hot melt adhesive film 24b to at least one surface of the continuous fibrous substrate 24a. Guide rollers 50 are used to bring the fibrous substrate 24a into contact with the hot melt adhesive film 24b. The substrate 24a and film 24b are passed through an oven 52 or otherwise heated to at least partially melt the thermoplastic hot melt adhesive of the film 24b. While still at least partially melted, the heated film 24b and the substrate 24a are passed through pinch rollers 54. The heat and pressure cause the thermoplastic hot melt adhesive to adhere/tack to the continuous fibrous substrate 24a. During processing, the hot melt adhesive of the film 24b may permeate into the continuous fibrous substrate 24a. Alternatively, the embodiment of FIG. 6 may be practiced without the oven 52 and a premelting/fusing step.

Another embodiment of a continuous process for preparing the reinforcement backing 24 is shown in FIG. 7. A bath 56 of a thermoplastic hot melt adhesive in molten form is provided. A coating roller 58 applies a film 24b of the thermoplastic hot melt adhesive from the bath 56 onto a surface of the continuous fibrous substrate 24a, where the hot melt adhesive film 24b solidifies.

The thermoplastic hot melt adhesive may have a melting temperature in a range of about 66° C. (150° F.) to about 148° C. (300° F.), more typically about 93° C. (200° F.) to about 122° C. (250° F.). Representative hot melt adhesives that may be used include polyolefins, such as propylene, ethylene, and styrene homopolymers, copolymers and terpolymers; polyvinyl acetates and ethylene vinyl acetate copolymers; polyurethanes; polyesters; polyamides, such as nylon and nylon-type adhesive films; ethylene-ethyl acrylate copolymers, styrene butadiene copolymers, styrene-isoprene-styrene copolymers, and copolymers, terpolymers, and blends including one or more of the same. The hot melt adhesive film 24b may contain additional ingredients such as processing aids, tackifying agents, plasticizers, fillers, pigments, dyes, etc. An example of a commercial hot melt adhesive film 24b useful in the exemplary embodiments described herein is “Advantage” adhesives made by HMT Manufacturing, Inc.

Methods of making a reinforced door skin 12, 14 and a reinforced door 10 including one or more of the reinforced door skins 12, 14 are now described in greater detail.

As shown in step 30 in FIG. 3 and schematically in FIG. 4, a barrier layer 44 is placed on the lower mold die 42 of a matched die set. The barrier layer 44 is made of a material that will prevent any of the thermoplastic hot melt adhesive of film 24b that has permeated through the continuous fibrous substrate 24a from reaching and adhering to the lower die 40. Nylon, coextruded nylon, waxed paper, dry paper, etc. are examples of suitable materials for the barrier layer 44.

The reinforcement backing 24 is provided and loaded in the compression apparatus on the barrier layer 44, as shown by step 31 in FIG. 3, with the thermoplastic hot melt adhesive film 24b facing upward, as shown in FIG. 4. It should be understood that “provided” and “providing” as used herein can encompass obtaining the preformed board 22 (or other components and parts of the reinforced door skin 12, 14 and door 10 described herein) from a supplier, manufacturer, shipper, etc., or making the part oneself (for example, as described in connection with FIGS. 6 and 7). Neither the preformed board 22 nor the reinforcement backing 24 needs to be preheated prior to its loading into the compression mold apparatus, although preheating is optional. As shown in FIG. 4, the reinforcement backing 24 also does not need to be pre-shaped to possess the contours 20 of the preformed board 22 prior to loading the backing 24 into the compression mold apparatus, although pre-shaping of the reinforcement backing 24 is optional. The reinforcement backing 24 may be relatively taut as shown in FIG. 4 when loaded in the apparatus. However, the reinforcement backing 24 desirably is sufficiently flexible, pliable, and/or stretchable to permit it to conform to the recesses 41 and projections 43 of the mold dies 40, 42 during pressing so that the pressed reinforcement backing 24 possesses the same/matching contours 20 as the preformed board 22.

As shown by step 32 of FIG. 3, the preformed board 22 is loaded directly on the reinforcement backing 24 in the compression mold apparatus. The preformed board 22 is at least substantially completely cured into a thermoset part prior to loading it in the compression mold apparatus. Thus, the contours 20 and surface embossments, if any, are already shaped and cured/set in the preformed board 22 before the preformed board 22 is loaded into the compression mold apparatus. As mentioned above, the preformed board 22 does not need to be preheated prior to loading it into the compression mold apparatus although, as discussed below, the compression mold apparatus may be preheated.

The formation and curing of thermosetting compositions into pre-formed boards 22 is known in the art and is typically carried out by compression molding, such as described in, for example, U.S. Patent Publication No. 2010/0175346 or U.S. Pat. No. 6,868,644. The preformed boards 22 may be made using other techniques, such as pultrusion, extrusion, and injection molding.

As best shown in FIG. 4, in the illustrated and other exemplary embodiments, the cavity-forming surfaces of the mold dies 40, 42 or other mold parts match the contours of the preformed board 22, such that the preformed board 22 has contours substantially identical to the mold-cavity defining surfaces of the compression mold apparatus. For example, the lower mold die 40 has a recess 41 and the upper mold die 42 has a projection 43 substantially identical in shape to the lower and upper surfaces of the contour 20, respectively, of the preformed board 22 to allow the contour 20 to nest in the recess 41. The lower and upper mold dies 40, 42 may be identical or substantially similar to a lower and upper mold die (not shown) used for forming and curing the preformed board 22. By matching the shape and contours of the lower and upper mold dies 40, 42 to the lower (interior) and upper (exterior) face of the preformed board 22, pressure applied by the compression mold apparatus or other pressing apparatus is substantially uniformly distributed. Hence, there is lesser likelihood that the preformed board 22 will be deformed (e.g., stretched) or damaged (e.g., fractured) during the pressing step 33, discussed below, and a greater likelihood of the reinforcement backing 24 having uniform weight distribution and impact resistance.

Although a similar barrier layer to barrier layer 44 discussed above may be placed between the preformed board 22 and the upper mold die 42, none is needed or desired because the preformed board 22 typically is sufficiently non-porous to prevent the adhesive of the thermoplastic hot melt adhesive film 24b from permeating through the preformed board 22 to the upper mold die 42.

As best shown in FIGS. 4 and 5, the preformed board 22, the reinforcement backing 24, and the barrier layer 44 are greater in lateral dimension than the mold dies 40, 42, so that overhang remains after the molding step 33 is carried out. The overhang may be removed in a post-press cutting step. Overhang may be, for example, on the order of about 1.27 cm (0.5 inch) to about 2.54 cm (1.0 inch). The overhang optionally may be substantially reduced or even eliminated using the method of the present invention, as shown in FIGS. 4A and 5A.

In the description above, the preformed board 22, the reinforcement backing 24, and the barrier layer 44 are separately and successively introduced into the compressing mold apparatus in steps 30-32. Alternatively, the preformed board 22, the reinforcement backing 24, and the barrier layer 44 may be layered together prior to loading into the compression mold apparatus. According to another alternative embodiment, the preformed board 22 and the reinforcement backing 24 are layered together prior to loading, and are loaded into the compression mold apparatus separately from the barrier layer 44. According to still another alternative embodiment, the reinforcement backing 24 and the barrier layer 44 are layered together prior to loading, and are loaded into the compression mold apparatus separately from the preformed board 22. The reinforcement backing 24 and/or the barrier layer 44 may be fed to the compression mold apparatus as “endless” sheets on a continuous conveyor and cut to size before, while, or after being introduced into the compression mold apparatus. Prior to being loaded and preferably when first being introduced into the compression mold apparatus, the hot melt adhesive film 24b of the reinforcement backing 24 is in a solid, non-melted state.

The lower mold die 40 and/or the upper mold die 42 of the compression mold apparatus may be preheated. The temperature inside the mold cavity of the compression mold apparatus is sufficiently high to melt the thermoplastic hot melt adhesive of the reinforcement backing 24. Typically, the mold platens are preheated to temperatures in the range of about 66° C. (150° F.) to about 122° C. (250° F.), more typically in a range of about 85° C. (185° F.) to about 122° C. (250° F.), more typically in a range of about 93° C. (200° F.) to about 122° C. (250° F.), although temperature may vary depending upon the adhesive selected. Because the preformed board 22 has already been completely or substantially completely cured into a thermoset before the preformed board 22 is loaded into the compression mold apparatus, and further because the adhesive film 24b is a thermoplastic hot melt adhesive with relatively low melt temperatures compared to the cure temperature of the thermoset of the preformed board 22, the temperature inside the compression mold apparatus does not need to reach thermoset cure temperatures, which typically are about 141° C. (285° F.) to about 166° C. (330° F.).

Once the compression mold apparatus has been loaded, the mold die 40 and 42 of the compression mold apparatus are desirably closed at a relatively slow speed of about 0.635 cm (0.25 inch) per second to about 12.7 cm (5 inches) per second. Relatively slow closing speeds will prevent or at least substantially reduce the possibility that the relative movement of the mold die(s) 40 and/or 42 will cause any of the preformed board 22, the reinforcement backing 24, and the barrier layer 44 to wrinkle or otherwise shift, and will allow the reinforcement backing 24 to stretch, if necessary. Relative movement of the compression mold apparatus during opening and closing may involve movement of only one of the mold die, i.e., die 40 or 42, or movement of both mold dies 40 and 42. Typically, only the upper die 42 is moved.

Pressing 33 (FIG. 3) in the compression mold apparatus desirably is performed for sufficient time to completely melt the thermoplastic hot melt adhesive. Although the hold time for pressing 33 will depend on mold temperature, generally a hold time of about 5 seconds to about 25 seconds will suffice. As the die temperature is raised, less hold time is required. As the die temperature is lowered, more hold time is required.

FIG. 5 shows the door skin components 22, 24 and barrier layer 44 loaded in the compression mold apparatus, and the apparatus in a closed position. The weight of the die tool and the ram(s) (not shown) may supply sufficient pressure for the pressing step 33 without requiring the application of additional pressure. The die tool and ram(s) may apply, for example, anywhere from about 2 pounds per square inch (psi) to about 1000 psi of pressure. The pressure is sufficient to conform the reinforcement backing 24 to the shape of the preformed board 22, as shown in FIG. 5. Depending upon the applied pressure, the pressure may decrease the thickness of (that is, compresses) the reinforcement backing 24. The preformed board 22 experiences substantially no compression during the pressing step.

In a non-continuous process, once pressing 33 is completed, one or both of the mold dies 40, 42 are moved away from the other to open the compression mold apparatus for accessing the mold cavity and removing the molded reinforced door skin. Press opening may be performed at a relatively slow rate of, for example, about 2.54 cm (1 inch) per second to about 25.4 cm (10 inches) per second to avoid damage to the compressed reinforced door skin. The opening rate may be sufficiently slow that the reinforced door skin is not pulled off of the lower die 40 by the opening movement of the dies. As the compression mold apparatus is opened, the reinforced door skin 12, 14 begins to cool 34. The reinforced door skin 12, 14 is removed from the compression mold apparatus and allowed to cool further. As the reinforced door skin 12, 14 cools, the bond between the hot melt adhesive and the preformed board 22 to the reinforcement backing 24 forms and/or strengthens.

In step 35 of FIG. 3, the reinforcement door skins 12, 14 are secured to opposite sides of the door support or frame 26. The reinforcement door skins 12, 14 are then cut so as to be co-extensive with the frame 26.

Modifications and variations to the embodiments described herein may be practiced. For example, although the exemplary embodiments are described above in connection with the use of a compression mold apparatus, other pressing apparatus may be used, such as a bag press assembly, as described in U.S. Pat. No. 8,256,177, or a flexible foam press. As described therein, a bag press assembly may include an inflatable membrane as the upper die/platen. As the membrane fills with air, it expands and assumes a shape complementary to that of the door skin. A commercially available press that does not require hydraulic cylinder rams is the ThermoFormer three dimensional vacuum former of Almex, a division of Black Bros. Co. As another modification, the reinforcement backing 22 may comprise multiple pieces and/or multiple layers, as previously mentioned.

There are many advantages to exemplary embodiments described herein over conventional methods in which fiberglass reinforcement is present in the mold cavity as the SMC or other thermosetting material is cured and formed into a door skin. For one, the door skin scrap rate can be drastically reduced using exemplary embodiments described herein. Whereas conventional methods may involve door skin scrap rates of 15-30%, early testing has demonstrated that exemplary embodiments described herein may produce scrap rates as low as 1%. Because the SMC or other polymeric material has already been cured and preformed into a door skin before the fibrous reinforcement backing is introduced, there is lesser likelihood that the fibers of the reinforcement backing will bleed through the door skin.

Another advantage of exemplary embodiments described herein is that greater inventories of preformed boards may be made and stored without requiring separate storage space for reinforced door skins and non-reinforced door skins. That is, the same preformed boards may be used to make reinforced door skins and non-reinforced door skins, and hence those preformed boards may be stored together. The preformed boards can be made in advance and stored until such time as needed, e.g., until a sales order is received. Thus, an end consumer or contractor can special order any type of preformed door skin to be made into a high impact resistant door skin according to the embodiments of the present invention. The preform boards for the orders can be obtained from the same stock, irrespective of whether the order is for a reinforced door skin or a non-reinforced door skin. As a result, high impact resistant doors can be made of any style and/or size efficiently, without a high degree of equipment changeover, with lower capital investment and production costs, and without accumulating a large inventory of reinforced doors.

Yet another advantage of exemplary embodiments is that the process may be practiced with no or lesser reinforcement backing overhang than required in conventional processes. The elimination of overhang can lessen equipment damage, particularly damage caused by the abrasive reinforcement backing 24 of the overhang being cut by the close-off shear ends of the compression mold apparatus. Additionally, in conventional processes, because the sheet molding material essentially liquefies during heating and pressing, the reinforcement backing may “float” on the SMC during pressing, thereby displacing the reinforcement backing. In exemplary embodiments described herein, the door skin is preformed and hence does not liquefy or cause float to the reinforcement backing. For example, the thermosets of SMC materials of the preformed boards 22 are already cured or substantially cured. The reinforcement backing is much more likely to stay in place, particularly in view of the matching between the contoured features of the preformed board and the cavity-defining surfaces of the matching mold dies. Hence, overhang, which conventionally is required in order to compensate for movement of the door skin materials during molding, is not needed or at least can be reduced.

Exemplary embodiments described herein possess still further advantages over processes that spray chopped fibers, such as disclosed in U.S. Pat. No. 8,256,177. For example, volatile compounds are not needed in the exemplary embodiments described herein, and hence EPA compliance is simplified. Also, exemplary embodiments described herein may be practiced without regenerative thermal oxidizer (RTO) units for burning off volatiles or scrubbers. The ability to use preformed boards and pre-prepared reinforcing backing sheets and the like makes it possible to eliminate chopped fiber spraying. Preformed boards and reinforcement backings are more easily placed by an operator and/or a mechanized system than sprayed chopped fibers, simplifying handling and processing.

The reinforced doors made in accordance with exemplary embodiments described herein may pass impact resistance performance tests, such as ASTM test standards and Florida Building Code standards. The reinforcement backing 24 is believed to dissipate the energy absorbed by the door skin in an impact test (such as generated by a flying board). This energy dissipation may be the result of transition of the energy outward to the frame, energy absorbed by the reinforcement, or a combination thereof. Additionally, the reinforcement backing may provide the door with sufficient strength to permit mounting of door handles and locks without requiring that a lockblock be incorporated into the frame. Thus, the door frame structure and its production may be simplified

### Examples

Reinforced door skins were prepared in accordance with an embodiment of the invention by laminating a preformed SMC skin having approximately 20 weight percent fibers, a commercially available Chomarat (D3/300) reinforcement mat made of chopped glass fibers stitched onto a synthetic polypropylene core, and ethylene vinyl acetate based adhesive film from HMT Manufacturing. The laminate was pressed in a matched die set having dies with cavity-forming surfaces that matched the shape of the preformed SMC skin. The pressing conditions were as follows: tool platen temperature: approximately 107° C. (225° F.) to approximately 116° C. (240° F.), press time 20 second; glue line temperature: approximately 85° C. (185° C.) to approximately 93° C. (200° F.); pressure on part: 25 psi. After pressing, the door skins were stacked. The door skins were prepared into reinforced doors having features set forth in the table below.

| | |
|---|---|
| Size of Slab | 35¾″ × 79″ |
| Type of Skin | Smooth fiberglass with laminated conforming |
| | mat |
| Panel Config. | 6 Panel |
| Type of Lock Set | Standard lock set with Masonite Spec |
| Jamb Material | Composite |
| Sill | Entry Inswing |
| Hinge Prep | Masonite Spec |
| Hinge/Latch Stile | (⅝″ Pine Cap\|1.25″ LVL) |
| Construction | |

The laminated fiberglass mats were subject to the following: TAS 201-94 Section 6.3.2.1 large missile impact test; ASTM E-1886-97 standard test method for performance of exterior windows, curtain walls, doors, and storm shutters impacted by missile(s) and exposed to cyclic pressure differentials; and TAS 203-94 criteria for testing products subject to cyclic wind pressure loading. The equipment used to conduct these tests met the requirements of TAS 203-94 and TAS 201-94. The large missile impact cannon was calibrated before testing was conducted.

The door samples were installed as side-hinged doors in a door frame consistent with manufacturer installation instructions that accompany commercially sold side-hinged door units. Also the doors were prepared in accordance with TAS 201. Three prototype smooth fiberglass door samples with a laminated conforming mat were tested to TAS 201, using the Large Missile Impact cannon to deliver 2 impacts of the missile in the locations designated by test standard at 35 mph. The doors are then subjected to Air Cycling Load equipment (TAS 203, ASTM E-1886-97) for confirmation of pass/fail condition.

The laminated conforming mat doors passed the impact test. This determination was confirmed by the Cycle Air Load test in TAS 203/ASTM E-1886, although there was some variation in the impact performance of the corner shot.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

What is claimed is:

1. A method of making a reinforced door skin, comprising:
providing a reinforcement backing comprising a fibrous substrate layered with a solid-state thermoplastic hot melt adhesive;
pressing the reinforcement backing and a preformed board having a door skin shape against one another at a temperature above a melt temperature of the thermoplastic hot melt adhesive and at sufficiently high pressure to conform the reinforcement backing to the door skin shape of the preformed board; and
cooling the thermoplastic hot melt adhesive to form a reinforced door skin, the thermoplastic hot melt adhesive fusing the fibrous substrate to the preformed board of the reinforced door skin.

2. The method of claim 1, wherein the door skin shape is contoured, and wherein said pressing is performed in a pressing apparatus having cavity-forming surfaces that are substantially identical in contour to the contoured door skin shape of the preformed board.

3. The method of claim 2, wherein the contoured door skin shape not altered during said pressing.

4. The method of claim 1, wherein the fibrous substrate is a unitary piece extending continuously across an entire width and length of the reinforcement backing.

5. The method of claim 1, wherein said pressing is performed in a pressing apparatus heated to about 66° C. to about 122° C.

6. The method of claim 1, wherein the fibrous substrate comprises a woven, mesh, a felt, or a knitted substrate.

7. The method of claim 1, wherein the fibrous substrate comprises fiberglass.

8. The method of claim 1, wherein the thermoplastic hot melt adhesive comprises polypropylene, polyethylene, polystyrene, polyvinyl acetate, a polyurethane, a polyester, a polyamide, an ethylene-ethyl acrylate polymer, a styrene-butadiene polymer, a styrene-isoprene-styrene polymer, copolymers thereof, terpolymers thereof, or blends thereof.

9. The method of claim 1, wherein the preformed substrate comprises a fiberglass-reinforced sheet molding compound substantially or fully cured into a thermoset prior to said pressing.

10. A reinforced door skin made according to the method of claim 1, comprising:
a preformed board configured and dimensioned as a door skin having an exterior surface and an opposite interior surface;
a fibrous substrate; and
a thermoplastic hot melt adhesive fusing the fibrous substrate to the interior surface of the preformed board.

11. A method of making a door assembly, comprising:
providing a reinforcement backing comprising a fibrous substrate layered with a solid-state thermoplastic hot melt adhesive;
pressing the reinforcement backing and a preformed board having a door skin shape against one another at a temperature above a melt temperature of the thermoplastic hot melt adhesive and at sufficiently high pressure to conform the reinforcement backing to the door skin shape of the preformed board;
cooling the thermoplastic hot melt adhesive to form a reinforced door skin, the thermoplastic hot melt adhesive fusing the fibrous substrate to the preformed board of the reinforced door skin; and
securing the reinforced door skin to a door support.

12. The method of claim 11, wherein the door skin shape is contoured, and wherein said pressing is performed in a pressing apparatus having cavity-forming surfaces that are substantially identical in contour to the contoured door skin shape of the preformed board.

13. The method of claim 12, wherein the contoured door skin shape not altered during said pressing.

14. The method of claim 11, wherein the fibrous substrate is a unitary piece extending continuously across an entire width and length of the reinforcement backing.

15. The method of claim 11, wherein said pressing is performed in a pressing apparatus heated to about 66° C. to about 122° C.

16. The method of claim 11, wherein the fibrous substrate comprises a woven, mesh, a felt, or a knitted substrate.

17. The method of claim 11, wherein the fibrous substrate comprises fiberglass.

18. The method of claim 11, wherein the thermoplastic hot melt adhesive comprises polypropylene, polyethylene, polystyrene, polyvinyl acetate, a polyurethane, a polyester, a polyamide, an ethylene-ethyl acrylate polymer, a styrene-butadiene polymer, a styrene-isoprene-styrene polymer, copolymers thereof, terpolymers thereof, or blends thereof.

19. The method of claim 11, wherein the preformed substrate comprises a fiberglass-reinforced sheet molding compound substantially or fully cured into a thermoset prior to said pressing.

20. A door assembly made according to the method of claim 11, comprising:
a door support;
a reinforced first door skin secured to a first side of the door support; and
a second door skin secured to an opposite second side of the door support, wherein at least one of the first and second door skins comprises a preformed board configured and dimensioned as a door skin having an exterior surface and an opposite interior surface, a fibrous substrate, and a thermoplastic hot melt adhesive that fuses the fibrous substrate to the interior surface of the preformed board.
